(19) United States
(12) Patent Application Publication
(10) Pub. No.: US 2013/0342922 A1
(43) Pub. Date: Dec. 26, 2013

(54) MEDICAL MAGNIFICATION DEVICE

(71) Applicant: Klaus-Peter Jurkat, Berlin (DE)

(72) Inventor: Klaus-Peter Jurkat, Berlin (DE)

(21) Appl. No.: 13/689,901

(22) Filed: Nov. 30, 2012

Related U.S. Application Data
(63) Continuation of application No. PCT/EP2011/059280, filed on Jun. 6, 2011.

(30) Foreign Application Priority Data
Jun. 7, 2010 (DE) 20 2010 007 662.5

(51) Int. Cl. G02B 25/02

(52) U.S. Cl. CPC G02B 25/02
USPC 359/802

(57) ABSTRACT

The invention relates to a medical magnification device which has an optical unit with an optical axis, illuminating means and attachment elements, wherein the optical unit has at the proximal end, an eyepiece of monocular design, and the illuminating means is configured in the form of a hollow cylinder, is connected at a distal end to the optical unit and is coaxial with respect to the optical axis generating a concentric illumination pattern and the attachment elements include means that can be connected to the optical unit and that are configured so that the optical unit is adjustable in any direction.

### RELATED APPLICATIONS

This application is a continuation of PCT/EP2011/059280, filed on Jun. 6, 2011, claiming priority from German Patent Application DE 20 2010 007 662.5, filed on Jun. 7, 2010, both of which are incorporated in their entirety by this reference.

### FIELD OF THE INVENTION

The invention relates to a device for visual magnification of objects in medical applications, in particular in dentistry, ear nose and throat medicine for diagnosing very small details in small and particularly deep cavities.

### BACKGROUND OF THE INVENTION

In the field of the invention for example magnifying eye glasses are being used which, however, only provide little magnification. In the art furthermore surgery microscopes are known for the medical field in particular in surgery and micro surgery which are microscopes with approximately 6 power to 40 power magnification. The surgery microscopes have a stronger magnification compared to a magnifying eye glass, however, they require particularly stable positioning and typically very uncomfortable and complex support for the patient.

A surgery microscope is also being used as a technical aide during dental treatments, in particular for procedures where very small areas are treated in a tooth. Thus, it has the great advantage of making structures visible that are not visible to the bare eye. The most important application for the surgery microscope in dentistry is treating an interior of a tooth with tooth marrow and tooth root also known as root treatment. Furthermore surgery microscopes are used for detecting cavities.

For inspecting a root canal with a diameter of approximately 1 mm and a depth of approx. 12.5 mm the optical resolution when viewing with a bare eye is insufficient. When using conventional magnifying eye glasses with two power to four power magnification the optical resolution is already improved. In order to simultaneously optimize illumination an additional head lamp is required. Through the combination of a magnifying eye glass and a head lamp the root canal can be sufficiently analyzed up to a depth of approximately 5 mm. For greater root canal depths surgery microscopes with almost parallel light routing are required. The surgery microscope is thus supported above the dentistry chair through pivot arms and performs various functions. The surgery microscopes known in the art are binoculars and therefore have a respective magnification arrangement for each eye.

Conventional surgery microscopes are continuously pivotable in all dimensions, but only within limits, in order to make curved channels and cavities like curved root canals in an interior of a tooth visible. The optical magnification is therefore typically variable adjustable so that on the one hand side small details of structures are visible and on the other hand side an overview of the entire surgery area is provided.

From DE 296 04 848 U1 a binocular surgery microscope for dentistry procedures, in particular procedures in teeth and at a jaw is provided. The surgery microscope is arranged downward oriented so that the surgeon can look through the eye pieces and a front lens into the surgery area. The illumination of the object having surgery is provided through the front lens, wherein the light is run through a light conductor or emitted by a light source within the microscope.

The binocular configuration requires comparatively stable support for the microscope which is conventionally implemented through a ceiling mount that does not have any play and which has a vibration absorber. Thus, the objective lens is vertically oriented from the top down and can only be pivoted in lateral direction with substantial complexity. The treating physician furthermore has to take a very precise position relative to the two eye pieces and has to maintain the position constant. Already a slight movements and rotation of the head lead to double images and other impairments. The illumination of the surgery area is limited due to configurative reasons by the operating distance and by the distance between light source and objective lens. Furthermore stereoscopic vision is not possible for geometric reasons in very narrow and tight channels. The adjustment of the operating distance is typically predetermined at approximately 250 mm through a non variable objective lens and has to be adjusted through complex mechanical configurations. Furthermore performing surgeries with a surgery microscope requires an optimum and precise support for the patient.

As alternative thereto a surgery microscope is known from DE 102 03 215 B4 that includes an objective lens with a light source for object illumination, an eye piece and a camera, wherein the eye piece represents an object to be examined for visual inspection and the camera captures an image of the object through the objective lens. Thus, the eye piece together with a reproduction device is configured motion decoupled relative to the object and the camera. For this purpose the eye piece is attached at an eye piece support that is adjustable relative to the objective lens, wherein the eye piece support is supported in turn at a microscope support supporting the objective lens and the camera. Thus, the objective lens and the eye piece position are decoupled from one another.

Also in DE 20 2006 020 039 U1 a stereoscopic monitoring device with an illumination device and variable aperture for imaging an object and/or an intermediary image generated by an object is disclosed, wherein the variable aperture is provided for a beam path of the illumination device. The variable aperture in which a light source is integrated is controllable within limits to generate a particular illumination geometry and/or variable with respect to its position.

### BRIEF SUMMARY OF THE INVENTION

Thus, it is an object of the present invention to provide a device for visual magnification of objects in medical applications, in particular in dentistry and in ear, nose and throat medicine for diagnosing extremely small details in small and particularly deep cavities. The device shall thus be configured so that an optimum illumination of the object to be examined is provided when the device is operated during a surgical procedure. In particular for deep and tight structures a good illumination of the surgical area shall be provided with little glare and minimum shade. The device shall be suitable for dentistry, in particular for inspecting root canals and spaces between teeth. Operating the device shall be simple and ergonomical. It is another object to configure the device from a small number of components with simple configuration and thus producible in a cost effective manner with low complexity.

The object is achieved according to the invention through a medical magnification device. The device includes an optical unit with a optical axis, an illumination device and attachment elements, wherein the optical unit is configured with one eye piece and includes the eye piece at its proximal end. The proximal end of the optical unit is the end oriented towards the viewer. The viewer therefore looks into the optical unit at the proximal end.

At the distal end, this means the end of the optical unit that is oriented away from the viewer, the hollow cylindrical illumination device is provided in a direction of the optical axis, wherein the illumination device illuminates the area in the direction of the optical axis. According to the invention the illumination device is arranged coaxial to the optical axis and permanently connected with the optical unit. The illumination device generates an illumination pattern that is concentric to the optical axis of the optical unit, wherein the illumination pattern provides advantageous illumination of the objects to be examined. The permanent connection between the illumination device and the optical unit provides the adjustment of the device, in particular of the optical unit without requiring additional adjustment of the illumination device. The optical unit and the illumination device are advantageously adjusted in one step.

The attachment elements of the magnification device according to the invention furthermore include means that are connectable with the optical unit, wherein the means facilitate direction independent adjustability of the optical unit with reference to the patient. Thus, direction independent adjustability is the unrestricted movement of the optical unit in all directions. Thus, the optical unit is fixable in any desired orientation regardless of its position.

According to a preferred embodiment of the invention the illumination device includes illuminants configured as LEDs that are arranged in an annular manner about the optical axis. The LEDs are thus uniformly distributed at the circumference of the hollow cylindrical illumination device and thus in their entirety distributed in a coaxial manner about the optical axis. A coaxial uniform distribution of the LEDs about the circumference is an arrangement of the LEDs at uniform distances from the optical axis and therefore from the center axis of the illumination device. Due to the coaxial alignment of the illumination device with reference to the optical unit the optical axis and the center axis of the illumination device are arranged on top of one another. The optical axis of the optical unit and the center axis of the illumination device are identical. The illumination device is advantageously configured with four LEDs.

According to an advantageous embodiment of the invention the magnification device includes four electrically driven actuation motors which are electrically connected with a current source. The actuation motors are provided on the one hand side for focusing or driving a focusing device of the optical unit and on the other hand side for aligning the optical unit with reference to a position relative to the patient and/or the person performing the treatment through attachment elements, this means for position changes of the optical unit.

The optical unit, in particular the illumination device and the adjustment motors of the focusing device and the adjustment motors of the attachment elements are preferably connected with an electrical energy storage device, for example a battery configured as a power source. The illumination device and the adjustment motors can also be configured as consumers that are alternatively operable from the power grid. As an alternative to the configuration with electric actuation motors the optical unit, in particular the focusing device and the attachment elements are also manually operable so that the power supply of the magnification device according to the invention is limited to the illumination device.

According to a preferred embodiment of the invention the optical unit is expandable at the proximal end with an image capture device or the image capture device can be switched with the eye piece. Thus, the image capture device is configured as an eye piece, a monitor and/or camera for displaying and capturing images in the form of photos or films.

The focusing device of the optical unit is preferably configured adjustable for a focusing in a range between 20 cm and 40 cm. Focusing is thus performed directly at the optical unit. Advantageously the optical unit provides up to 12 power magnification up close, wherein the optimum is in a range of 8-12 power magnification. The value of the magnification is furthermore adjustable through a variation of the distance between the magnification device and the object to be examined and on the other hand side through an optical zoom device.

According to another configuration of the invention the means of the attachment elements for attaching the optical unit include holders, links and fixation devices. The attachment elements are thus preferably formed from spring arm supports with hinge links and with at least one ball joint so that the optical unit is infinitely adjustable with respect to the objective orientation.

The attachment elements are connected with the optical unit during operations or during the treatment or the procedure. The optical unit with the illumination device attached thereto is advantageously mountable at the treatment chair through the attachment elements and pivotably supported. When not in use the magnification device is demountable in a simple manner or pivotable out of the surgical area. The attachment elements can be disengaged from the treatment chair and also from the optical unit and are storable in few components.

Alternatively the optical unit with the illumination device is mountable through the attachment elements in an advantageous manner also at a conventional surgical lamp or configured so that it can be integrated in the surgical lamp. Depending on the requirements of the medical personnel with respect to surgical area illumination the optical unit according to the invention is also operable in place of the surgical lamp. The optical unit then replaces the surgical lamp.

The solution according to the invention thus has several advantages with respect to examining tight and deep cavities, for example tooth cavities which so far have only been feasible with stereo microscopes that had complex configurations and operations and where cost intensive to produce. The instant devices for visual magnification of objects in particular in the dental field provides the examination of cavities in intermediary spaces between teeth and irregularities of root canals of teeth for example in the channel path, the curvature, hidden branch offs, glue residuals or similar with optimum illumination of the object to be examined and simple and ergonomical operation. Through the device according to the invention that is producible with a small number of components and low engineering complexity the treatment quality can be increased and the treatment time can be reduced. Thus, the device is very effective and cost effective with respect to its purchase, maintenance and operations.

### BRIEF DESCRPTION OF THE DRAWINGS

Further details , features and advantages of the invention can be derived from the subsequent description of embodiments with reference to the associated drawing figures, wherein:

FIG. 1 illustrates a single eye piece device for visual magnification of objects in a lateral view;

FIG. 2 illustrates an optical unit and illumination device with optical pass through;

FIG. 3 illustrates a tooth with indicated outer tooth contour and root canal in a lateral view; and

FIG. 4 illustrates a tooth with an open root canal and an irregularity at the bottom of the root canal in top view.

### DETAILED DESCRPTION OF THE INVENTION

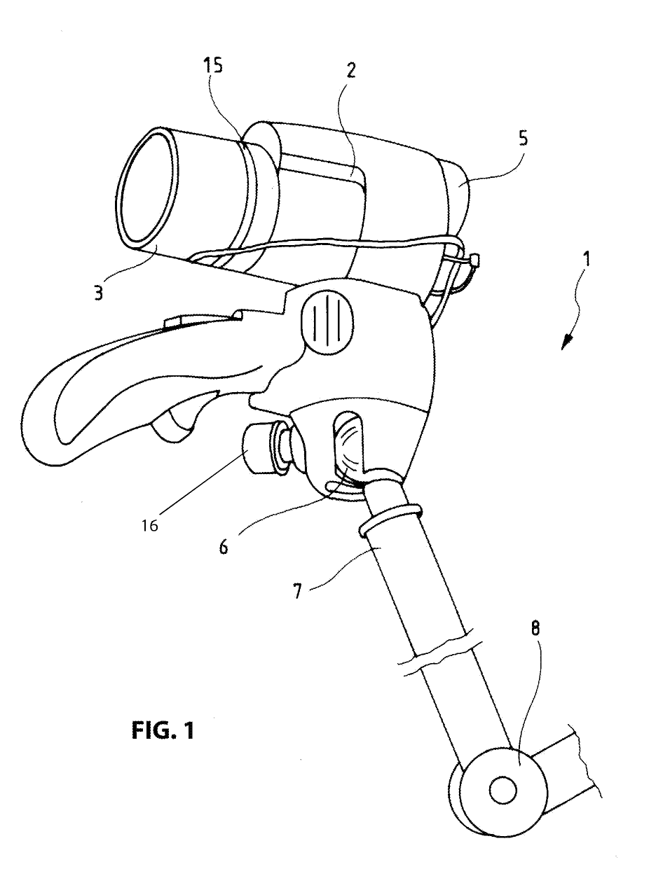

FIG. 1 illustrates a single eye piece magnification device 1 according to the invention for visual magnification of objects in a lateral view. The optical unit 2 configured as a one tube telescope includes an eye piece 5 at the proximal end, this means at the end oriented toward the viewer. At the distal end, or the end of the optical unit 2 oriented away from the viewer the optical unit 2 is provided with a manually operable focusing device 15 which is configured for focusing for a variable change of a distance between the object to be examined and the optical unit 2 in a range between 20 cm and 40 cm.

The optical unit 2 in particular the focusing device 15 according to an alternative embodiment is provided with electrically driven actuation motors and electrically connected with a power source. Thus, for example an electrical energy storage device like a battery or the public power grid is being used.

The optical unit 2 is thus provided for up to 12 power magnification, in particular for 8-12 power magnification for close range.

At the distal end the optical unit 2 is furthermore advantageously provided with an illumination device 3 in the direction of the optical axis. The illumination device 3 like the optical unit 2 is configured cylindrical in this portion and fixated in a rigid but advantageously disengageable manner at the optical unit 2. The illumination device 3 is thus configured in particular hollow cylindrical.

The optical unit 2 is in return coupled with the attachment elements 7. The attachment elements 7 advantageously include spring arm supports with hinge links 8 for a vertical and horizontal movement of the optical unit 2. Furthermore the attachment elements 7 are advantageously configured with a ball joint 6 so that the optical unit 2 is additionally pivotable in all directions. The attachment element 7 with the ball joint 6 and the hinges 8 of the spring arm supports thus facilitate a direction independent adjustability of the optical unit 2. The direction of the objective lens is consequently adjustable in all directions, this means without directional limitation. It is another advantage that the attachment elements 7 are furthermore provided with fixation devices 16 in order to fixate the desired and adjusted position of the optical unit 2 with respect to the patient and the treating person. The position of the optical unit 2 thus is also maintained during unexpected jolts. The attachment elements 7 represent an effective and thus simple engineering solution for a support through which the optical unit 2 can be mounted at the treatment chair without great effort.

According to an alternative embodiment the optical unit 2 with the illumination device 3 is also directly installable at the medical procedure light through attachment elements 7 or can be integrated into the medical procedure light.

The optical unit 2 can be further operated in a simple manner together with the attachment elements 7 and the illumination device 3, wherein the option for one man operation represents a particular advantage. Operations only require a very small learning time for the operator.

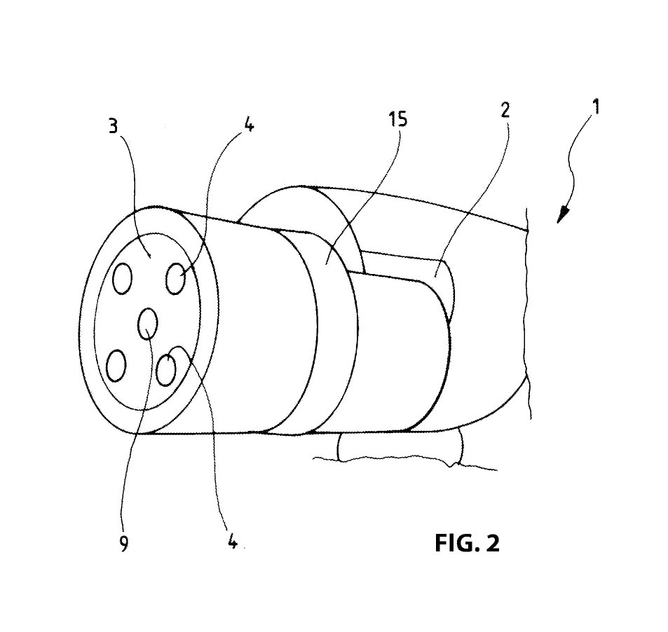

FIG. 2 illustrates the optical unit 2 and the illumination device 3 with the optical pass through 9. The optical pass through 9 is aligned with the optical axis of the optical unit 2.

The illumination device 3 is configured hollow cylindrical in a coaxial manner about the optical pass through 9 and includes LEDs 4 that are evenly distributed over the circumference. The LEDs 4 in their entirety are therefore also oriented in a coaxial manner, this means all LEDs 4 are offset by the same distance from the optical axis. Thus, preferably at least four LEDs 4 are provided, wherein also a greater number of LEDs 4 is feasible which are switchable in particular combinations. The LEDS 4 advantageously generate an illumination pattern that is concentric to the optical axis of the optical unit 2 and includes very good illumination of the objects to be examined, so that the conventional surgical procedure lights can be replaced.

The single eye piece magnification device 1 with coaxial concentric illumination according to the invention is therefore suitable in dentistry in particular for inspecting root canals and spaces between teeth. The deep and narrow tooth structures can be thus be illuminated almost without shadows.

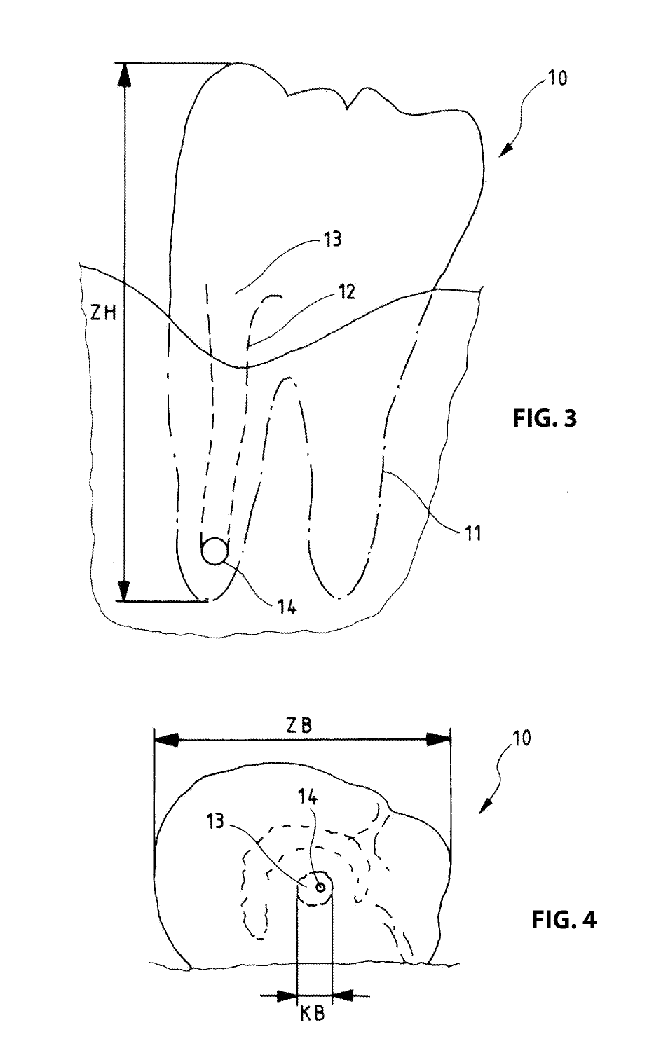

FIG. 3 illustrates a tooth 10 that is to be examined with an indicated outer tooth structure 11 and a root canal 12 in a side view. The tooth 10 includes for example a tooth height ZH of 18 mm, wherein the root canal 12 is configured with a diameter in the range of 1 mm and a depth of approximately 12-13 mm.

In the lower portion of the root canal 12 an irregularity 14 is indicated that needs to be examined. The irregularity 14 within the root canal 12 of a tooth 10 are for example the channel routing, in particular a channel curvature or hidden branch offs, glue residuals, cavities or similar. Also the nerves of the tooth 10 are easily visible within the root canal 12 through the magnification device 1 according to the invention.

FIG. 4 in analogy to FIG. 3 illustrates the tooth 10 with the open root canal 12 and an irregularity 14 at the base of the root canal 12 in top view.

The tooth 10 has for example a tooth width ZB of 10 mm. The channel inlet 13 is configured with a channel width KB of approximately 0.7 mm. Using the magnification device 1 according to the invention with the optical unit 2 and the illumination device 3 for visual magnification and visualizing objects for the near range facilitates in particular examining deep root channels, but also intermediary spaces between teeth in a simple and effective manner.

Typically it is feasible through the implementation of the magnification device 1 according to the invention for visual magnification of objects for use in medical applications in particular dentistry and ear nose and throat medicine to dispense with using very complex surgical microscopes and additional surgical lights.

### REFERENCE NUMERALS AND DESIGNATIONS

1 magnification device
2 optical unit
3 illumination device
4 LED
5 eye piece
6 ball joint
7 attachment element
8 hinge
9 optical aperture
10 tooth
11 outer tooth contour
12 root canal
13 channel inlet
14 irregularity
15 focusing device
16 fixation device
ZH tooth height
ZB tooth width
KB channel width

What is claimed is:

1. A medical magnification device, comprising:
an optical unit with an optical axis;
an illumination device; and
attachment elements,
wherein the optical unit includes one eye piece at its proximal end, wherein the eye piece is configured as a singular eye piece,
wherein the illumination device is configured hollow cylindrical,
wherein the illumination device is connected with the optical unit at its distal end,
wherein the illumination device is arranged coaxial with the optical axis so that it generates an illumination pattern that is concentric with the optical axis, and
wherein the attachment elements include adjustment devices that are connectable with the optical unit and configured so that the optical unit is adjustable in any direction.

2. The medical magnification device according to claim 1, wherein the illumination device includes LEDs that are arranged in a coaxial and annual manner about the optical axis and evenly distributed over a circumference.

3. The medical magnification device according to claim 1, wherein electrically driven actuation motors are provided for focusing and/or position change and electrically connected with a power source.

4. The medical magnification device according to claim 1, wherein at least one of the optical unit and the illumination device include an electrical energy storage device as a power source or are connected with a power grid.

5. The medical magnification device according to claim 1, wherein the optical unit is configured so that it is expandable at the proximal end with an image capture device or so that the eye piece is replaceable with the image capture device.

6. The medical magnification device according to claim 1,
wherein the optical unit includes a focusing device, and
wherein the focusing is configured adjustable at the optical unit in a range between 20 cm and 40 cm.

7. The medical magnification device according to claim 1, wherein the optical unit is configured with up to 12 power magnification for close range.

8. The medical magnification device according to claim 1, wherein the optical unit is configured with 8 to 12 power magnification for close range.

9. The medical magnification device according to claim 1, wherein the adjustment devices included in the attachment elements include a spring arm support with a hinge, a ball joint and fixation devices.

10. The medical magnification device according to claim 1, wherein the optical unit with the illumination device is mountable at a treatment chair through the attachment elements.
